(19) United States
(12) Patent Application Publication
(10) Pub. No.: US 2026/0087637 A1
(43) Pub. Date: Mar. 26, 2026

(54) OBJECT SEGMENTATION METHOD BASED ON MULTIMODAL DATA FUSION AND IMAGE ANNOTATION TOOL

(71) Applicant: JIANGNAN UNIVERSITY, Wuxi (CN)

(72) Inventors: Tianyang XU, Wuxi (CN); Xiaojun WU, Wuxi (CN)

(21) Appl. No.: 19/369,297

(22) Filed: Oct. 26, 2025

Related U.S. Application Data
(63) Continuation of application No. PCT/CN2025/110046, filed on Jul. 23, 2025.

(30) Foreign Application Priority Data
Sep. 24, 2024 (CN) 202411333445.1

(51) Int. Cl. G06T 7/174; G06T 5/50; G06T 7/33; G06T 11/00

(52) U.S. Cl. CPC G06T 7/174; G06T 5/50; G06T 7/337; G06T 11/00; G06T 2207/10024; G06T 2207/10028; G06T 2207/10048; G06T 2207/20221; G06T 2210/12

(57) ABSTRACT

The invention provides an object segmentation method based on multimodal data fusion and an image annotation tool. The method includes acquiring an initial RGB image, an initial infrared image, and an initial depth image that contain an object; aligning the initial RGB image, the initial infrared image, and the initial depth image to obtain a first RGB image, a first infrared image, and a first depth image; specifying an initial prompt point in the first RGB image, and acquiring first masks characterizing an object region from the images in different modalities; fusing pixel values of the images in different modalities based on the first masks of the first RGB image, the first infrared image, and the first depth image to obtain a second mask; and determining a minimum bounding box of the object, and calibrating the minimum bounding box to obtain a segmentation result of the object.

This application is a Continuation of PCT/CN2025/110046, filed on Jul. 23, 2025, which claims priority to Chinese Patent Application No. 202411333445.1, filed on Sep. 24, 2024, which is incorporated by reference for all purposes as if fully set forth herein.

### FIELD OF THE INVENTION

The present invention relates to the field of image segmentation technology, and in particular, to an object segmentation method based on multimodal data fusion and an image annotation tool.

### DESCRIPTION OF THE RELATED ART

With the advancement of computer vision technology, object segmentation has emerged as a critical research direction in the field of image processing. Object segmentation refers to the process of isolating specific objects of interest from images, which is essential for numerous applications such as autonomous driving, medical image analysis, and security surveillance systems. Conventional unimodal image segmentation methods (e.g., using only RGB images), while effective in certain scenarios, often struggle to achieve satisfactory segmentation results in complex environments. This limitation stems from the limited information representation capabilities of unimodal images when confronted with challenges such as illumination variations, occlusions, and indistinct textures.

In recent years, multimodal data fusion technology has gradually emerged as a prominent research focus. Information about target objects can be captured from diverse perspectives and dimensions by integrating multimodal data of RGB images, infrared images, depth images, and the like, thereby enhancing segmentation accuracy and robustness. Specifically, RGB images provide rich color information, facilitating the differentiation between distinct objects; infrared images are immune to lighting conditions, delivering thermal radiation information of objects during nighttime or low-light scenarios; and depth images deliver distance information of objects, enabling understanding of the spatial layout of objects.

However, effectively fusing multimodal data and applying it to object segmentation faces numerous challenges, including key technical issues such as alignment between images in different modalities, feature extraction, and information fusion. Particularly, how to accurately localize objects in multimodal images and generate high-quality segmentation masks is critical for achieving precise segmentation. While existing methods have made progress, their performance in complex environments still requires enhancement.

### SUMMARY OF THE INVENTION

For this, a technical problem to be resolved by the present invention is to overcome the deficiency in the related art that during object segmentation in a complex environment, due to the restrictions of unimodal information, it is often difficult to handle problems such as illumination variations, occlusions, and indistinct textures, resulting in insufficient segmentation precision and robustness.

To resolve the foregoing technical problems, the present invention provides an object segmentation method based on multimodal data fusion, including the following steps:
S1: acquiring an initial RGB image, an initial infrared image, and an initial depth image that contain an object;
S2: aligning the initial RGB image, the initial infrared image, and the initial depth image to obtain a first RGB image, a first infrared image, and a first depth image in a same coordinate system respectively;
S3: specifying an initial prompt point in the first RGB image, and acquiring first masks characterizing an object region from the first RGB image, the first infrared image, and the first depth image through the initial prompt point respectively;
S4: fusing pixel values of the images in different modalities based on the first masks of the first RGB image, the first infrared image, and the first depth image to obtain a second mask; and
S5: determining a minimum bounding box of the object based on the second mask, and calibrating the minimum bounding box to obtain a segmentation result of the object.

In an embodiment of the present invention, a method for obtaining a first RGB image, a first infrared image, and a first depth image in a same coordinate system in S2 is as follows:
S21: extracting feature points from the initial RGB image, the initial infrared image, and the initial depth image respectively, where each feature point has one feature descriptor, and the feature descriptor is an encoded vector that contains local information surrounding the feature point;
S22: constructing one approximate nearest neighbor search data structure for a feature descriptor set of each modality image;
S23: randomly selecting an approximate nearest neighbor search data structure of a modality image, and searching the current approximate nearest neighbor search data structure based on a feature point descriptor of another modality image to obtain candidate matching points;
S24: obtaining a geometric relationship estimation matrix between any two modality images based on the candidate matching points; and
S25: aligning all the modality images based on the geometric relationship estimation matrix to obtain the first RGB image, the first infrared image, and the first depth image in the same coordinate system.

In an embodiment of the present invention, a method for acquiring first masks characterizing an object region from the first RGB image, the first infrared image, and the first depth image in S3 is as follows:
S31: selecting one or more initial prompt points from the object region of the first RGB image; and
S32: obtaining the first mask of the first RGB image based on the initial prompt point, and mapping the coordinates of the initial prompt point into the first infrared image and the first depth image respectively to obtain the first mask of the first infrared image and the first mask of the first depth image.

In an embodiment of the present invention, a method for obtaining a second mask in S4 is as follows:
S41: obtaining information entropy of a channel of each modality image based on the first masks of the first RGB image, the first infrared image, and the first depth image;
S42: obtaining, based on the information entropy of the channel of each modality image, a weight corresponding to the first mask of the modality image;
S43: performing weighted fusion on the first masks of the three modality images based on the weight corresponding to the first mask of the modality image to obtain a fused value of each pixel; and
S44: comparing the fused value of each pixel with an estimation threshold, and retaining pixels whose fused value is greater than the estimation threshold to obtain the second mask.

In an embodiment of the present invention, a calculation method for obtaining information entropy of a channel of each modality image in S41 is as follows:
a calculation formula for the information entropy H_{RGB} of the channel of the first RGB image is:

$${H}_{R G B} = - {\sum }_{i = 0}^{255} {P}_{R G B} ( {i}_{R G B} ) log {P}_{R G B} ( {i}_{R G B} ) ,$$

a calculation formula for the information entropy H_{IR} of the channel of the first infrared image is:

$${H}_{IR} = - {\sum }_{i = 0}^{255} {P}_{IR} ( {i}_{IR} ) log {P}_{IR} ( {i}_{IR} ) ,$$

a calculation formula for the information entropy H_{Depth} of the channel of the first depth image is:

$${H}_{Depth} = - {\sum }_{i = 0}^{255} {P}_{Depth} ( {i}_{Depth} ) log {P}_{Depth} ( {i}_{Depth} ) ,$$

where P_{RGB}(i_{RGB}), P_{Depth}(i_{Depth}), and P_{IR}(i_{IR}) are respectively probability distributions of an RGB image, a depth image, and an infrared image on the pixel values i_{RGB}, i_{Depth}, and i_{IR}.

In an embodiment of the present invention, a method for obtaining a weight corresponding to the first mask of the modality image in S42 is: using the reciprocal of the information entropy of the channel of each modality image as the weight corresponding to the first mask.

In an embodiment of the present invention, a method for obtaining a fused value F(x,y) of each pixel in S43 is as follows:

$$F ( x , y ) = \frac{{W}_{R G B} \cdot {RGB}_{m a s k} ( x , y ) + {W}_{IR} \cdot {IR}_{m a s k} ( x , y ) + {W}_{D e p t h} \cdot {Depth}_{m a s k} ( x , y )}{{W}_{R G B} + {W}_{IR} + {W}_{D e p t h}} ,$$

where W_{RGB} is the weight of the channel of the first RGB image, and RGBₘₐₛₖ(x,y) is the coordinates of any pixel in the first mask of the first RGB image; W_{IR} is the weight of the channel of the first infrared image, IRₘₐₛₖ(x,y) is the coordinates of any pixel in the first mask of the first infrared image; and W_{Depth} is the weight of the channel of the first depth image, and Depthₘₐₛₖ(x,y) is the coordinates of any pixel in the first mask of the first depth image.

In an embodiment of the present invention, a method for calculating the estimation threshold θ is:

$$θ = \overline{H} + {σ}_{H} ,$$

where H̅ denotes a mean value of the information entropy of the channels of the modality images,

$$\overline{H} = \frac{{H}_{R G B} + {H}_{D e p t h} + {H}_{I R}}{3} ,$$

H_{RGB} is the information entropy of the first RGB image, H_{Depth} is the information entropy of the first depth image, and H_{IR} is the information entropy of the first infrared image; and σ_{H} denotes a standard deviation of the information entropy of the channels of the modality images, and

$${σ}_{H} = \sqrt{\frac{{( {H}_{R G B} - \overline{H} )}^{2} + {( {H}_{D e p t h} - \overline{H} )}^{2} + {( {H}_{I R} - \overline{H} )}^{2}}{3}} .$$

In an embodiment of the present invention, a method for obtaining a segmentation result of the object in S5 is as follows:
S51: superimposing the second mask on the initial RGB image to obtain the minimum bounding box of the object;
S52: traversing all pixels in the minimum bounding box, and converting an RGB value of each pixel to a color feature closest to the RGB value based on a color mapping table;
S53: processing the converted color features, and clustering a region in the minimum bounding box into N classes to obtain a clustering result;
S54: randomly selecting n points from a class with the largest total data amount of the clustering result as auxiliary points, and adding the auxiliary points to a prompt point set to obtain an updated prompt point set;
S55: generating a new mask based on the updated prompt point set, and calculating a change in the intersection over union between the current mask and a mask generated in a previous iteration; and
S56: determining whether the change is less than a preset threshold:
if the change is not less than the preset threshold, returning to Step S54; and
if the change is less than the preset threshold, stopping iterations, outputting a current mask, and superimposing the current mask on the initial RGB image to obtain the segmentation result of the object.

The present invention further provides an image annotation tool, including the following modules:
a receiving module, configured to receive at least one creation instruction input through an object interface, and when a plurality of creation instructions are input, queue the creation instructions based on priority or submission order;
an acquisition module, configured to acquire a target quantity of images to be annotated based on a resource address included in the creation instruction;
an annotation module, configured to automatically annotate the image to be annotated using the object segmentation method based on multimodal data fusion, and display an annotation result on the object interface; and
a saving module, configured to save the annotation result in multiple file formats.

Compared with the prior art, the foregoing technical solution of the present invention has the following advantages:

1. Multimodal data fusion: The method effectively resolves the inaccuracy and instability problems of conventional unimodal segmentation technology by integrating multimodal data of RGB images, infrared images, and depth images, thereby improving segmentation precision, can further provide more comprehensive object information in different conditions, thereby enhancing the adaptability to complex environments, and is applicable to various application scenarios such as medical image analysis, autonomous driving, and security surveillance, exhibiting excellent technical value and broad application prospects.

2. Precise alignment: Feature points are extracted and matched for images in different modalities, and alignment is performed using a geometric relationship estimation matrix, thereby ensuring the precise alignment of multimodal images in a same coordinate system, and reducing errors caused by coordinate inconsistency.

3. Information entropy fusion: The method can effectively fuse information of images in different modalities by calculating information entropy of a channel of each modality image and determine a weight based on the reciprocal of the information entropy, thereby improving the appropriateness of mask generation.

4. Robustness enhancement: The method not only considers color information of RGB images but also uses the advantages of infrared images and depth images, and can provide a stable segmentation effect in various illumination conditions and complex backgrounds.

### BRIEF DESCRIPTION OF THE DRAWINGS

To make the content of the present invention clearer and more comprehensible, the present invention is further described in detail below with respect to specific embodiments of the present invention and with reference to the accompanying drawings.

FIG. 1 is a flowchart of an object segmentation method based on multimodal data fusion according to Embodiment 1 of the present invention;

FIG. 2 is a flowchart of a specific implementation of the object segmentation method based on multimodal data fusion according to Embodiment 1 of the present invention;

FIG. 3 is a flowchart of a method for obtaining a first RGB image, a first infrared image, and a first depth image in a same coordinate system according to Embodiment 1 of the present invention;

FIG. 4 is a flowchart of a method for acquiring first masks characterizing an object region from the first RGB image, the first infrared image, and the first depth image according to Embodiment 1 of the present invention;

FIG. 5 is a flowchart of a method for obtaining a second mask according to Embodiment 1 of the present invention;

FIG. 6 is a flowchart of a method for obtaining a segmentation result of an object according to Embodiment 1 of the present invention; and

FIG. 7 is a schematic structural diagram of an image annotation tool according to Embodiment 1 of the present invention.

Reference numerals in the accompanying drawings of the specification: 10, receiving module; 20, acquisition module; 30, annotation module; and 40, saving module.

### DETAILED DESCRIPTION OF THE PREFERRED EMBODIMENTS

The present invention is further described below with reference to the accompanying drawings and specific embodiments, to enable a person skilled in the art to better understand and implement the present invention. However, the embodiments are not used to limit the present invention.

### Embodiment 1

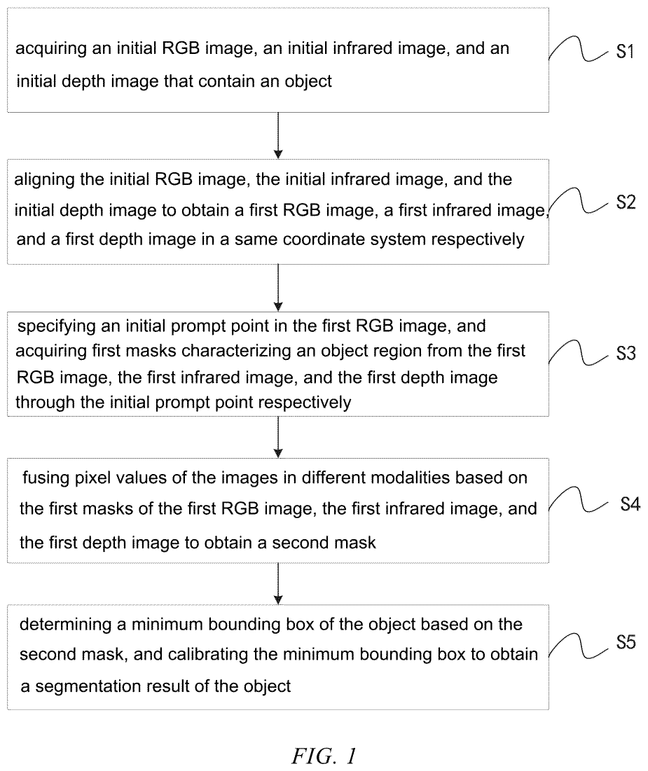

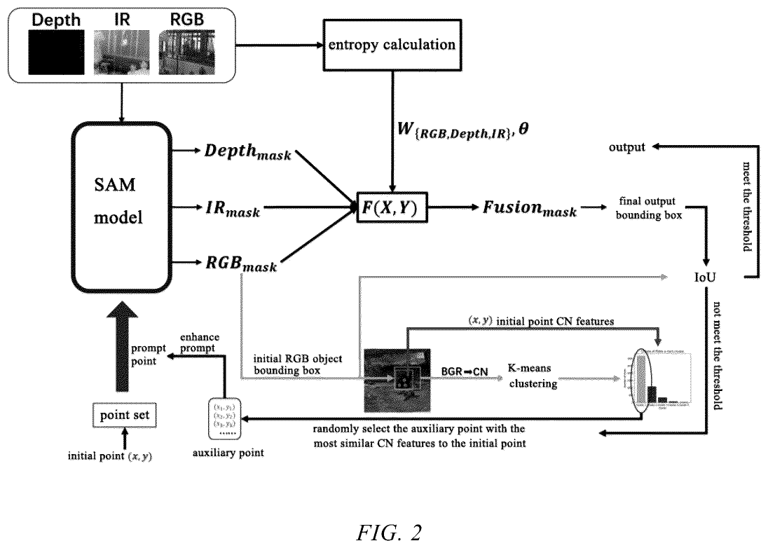

Referring to FIG. 1 and FIG. 2, the present invention provides an object segmentation method based on multimodal data fusion, including the following steps:
S1: acquiring an initial RGB image, an initial infrared image, and an initial depth image that contain an object;
S2: aligning the initial RGB image, the initial infrared image, and the initial depth image to obtain a first RGB image, a first infrared image, and a first depth image in a same coordinate system respectively;
S3: specifying an initial prompt point in the first RGB image, and acquiring first masks characterizing an object region from the first RGB image, the first infrared image, and the first depth image through the initial prompt point respectively;
S4: fusing pixel values of the images in different modalities based on the first masks of the first RGB image, the first infrared image, and the first depth image to obtain a second mask; and
S5: determining a minimum bounding box of the object based on the second mask, and calibrating the minimum bounding box to obtain a segmentation result of the object.

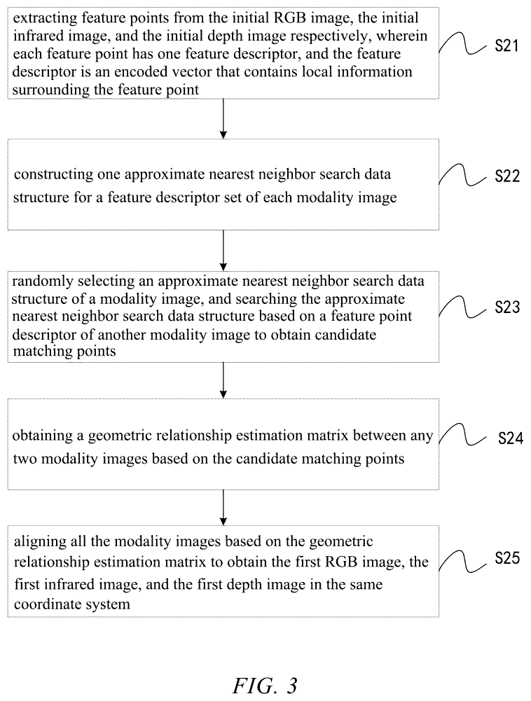

As shown in FIG. 3, a method for obtaining a first RGB image, a first infrared image, and a first depth image in a same coordinate system in S2 is as follows:
S21: extracting feature points from the initial RGB image, the initial infrared image, and the initial depth image respectively, where each feature point has one feature descriptor, and the feature descriptor is an encoded vector that contains local information surrounding the feature point;
S22: for search efficiency, constructing one approximate nearest neighbor search data structure for a feature descriptor set of each modality image using an approximate nearest neighbor search algorithm;
S23: randomly selecting an approximate nearest neighbor search data structure of a modality image, and searching the current approximate nearest neighbor search data structure based on a feature point descriptor of another modality image to obtain candidate matching points, where generally, feature points with the smallest distance are selected as the candidate matching points;
S24: to eliminate the impact of incorrect matching points, obtaining a geometric relationship estimation matrix between any two modality images based on the candidate matching points using a random sampling consensus algorithm, where if the two images are taken by slight movement at a fixed distance, a fundamental matrix may be estimated, and if the two images are images in different modalities from the same perspective, a homography matrix may be estimated; and
S25: aligning all the modality images based on the geometric relationship estimation matrix to obtain the first RGB image, the first infrared image, and the first depth image in the same coordinate system.

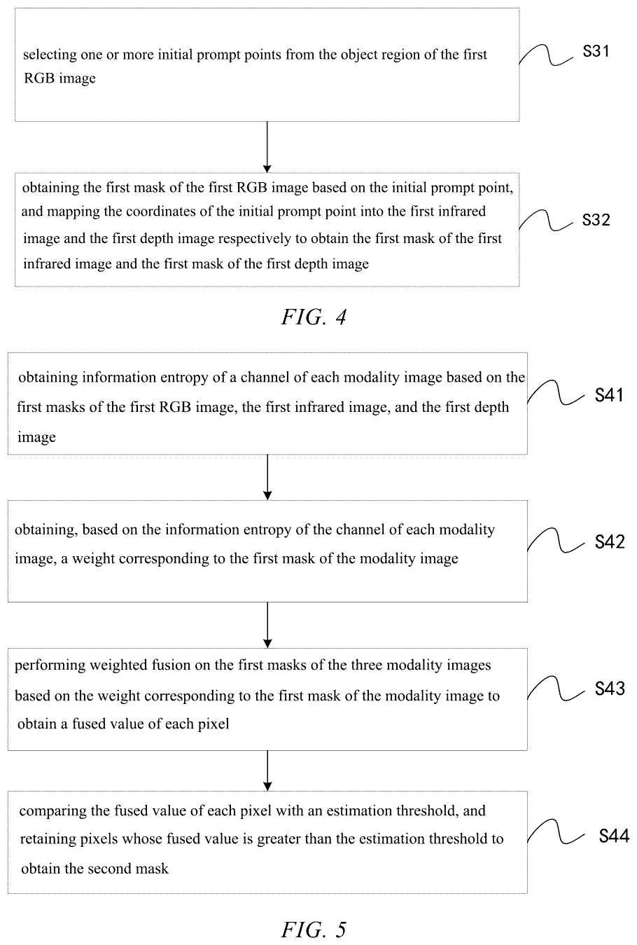

As shown in FIG. 4, a method for acquiring first masks characterizing an object region from the first RGB image, the first infrared image, and the first depth image in S3 is as follows:
S31: selecting one or more initial prompt points from the object region of the first RGB image; and
S32: obtaining the first mask of the first RGB image based on the initial prompt point, and mapping the coordinates of the initial prompt point into the first infrared image and the first depth image respectively to obtain the first mask of the first infrared image and the first mask of the first depth image.

As shown in FIG. 5, a method for obtaining a second mask in S4 is as follows:
S41: obtaining information entropy of a channel of each modality image based on the first masks of the first RGB image, the first infrared image, and the first depth image, where a calculation method for the information entropy is as follows:
a calculation formula for the information entropy H_{RGB} of the channel of the first RGB image is:

$${H}_{RGB} = - {\sum }_{i = 0}^{255} {P}_{RGB} ( {i}_{RGB} ) log {P}_{RGB} ( {i}_{RGB} ) ,$$

a calculation formula for the information entropy H_{IR} of the channel of the first infrared image is:

$${H}_{IR} = - {\sum }_{i = 0}^{255} {P}_{IR} ( {i}_{IR} ) log {P}_{IR} ( {i}_{IR} ) ,$$

a calculation formula for the information entropy H_{Depth} of the channel of the first depth image is:

$${H}_{Depth} = - {\sum }_{i = 0}^{255} {P}_{Depth} ( {i}_{Depth} ) log {P}_{Depth} ( {i}_{Depth} ) ,$$

where P_{RGB}(i_{RGB}), P_{Depth}(i_{Depth}), and P_{IR}(i_{IR}) are respectively probability distributions of an RGB image, a depth image, and an infrared image on the pixel values i_{RGB}, i_{Depth}, and i_{IR}.
S42: using, based on the information entropy of the channel of each modality image, the reciprocal of the information entropy of the channel of each modality image as a weight corresponding to the first mask of the modality image of the first mask;
S43: performing weighted fusion on the first masks of the three modality images based on the weight corresponding to the first mask of the modality image to obtain a fused value F(x,y) of each pixel, where a calculation formula for the fused value is:

$$F ( x , y ) = \frac{\begin{matrix}{W}_{RGB} \cdot {RGB}_{mask} ( x , y ) + \\ {W}_{IR} \cdot {IR}_{mask} ( x , y ) + {W}_{Depth} \cdot {Depth}_{mask} ( x , y )\end{matrix}}{{W}_{RGB} + {W}_{IR} + {W}_{Depth}} ,$$

where W_{RGB} is the weight of the channel of the first RGB image, and RGBₘₐₛₖ(x,y) is the coordinates of any pixel in the first mask of the first RGB image; W_{IR} is the weight of the channel of the first infrared image, IRₘₐₛₖ(x,y) is the coordinates of any pixel in the first mask of the first infrared image; and W_{Depth} is the weight of the channel of the first depth image, and Depthₘₐₛₖ(x,y) is the coordinates of any pixel in the first mask of the first depth image; and
S44: comparing the fused value F(x,y) of each pixel with an estimation threshold θ, and retaining pixels whose fused value F(x,y) is greater than the estimation threshold θ to obtain the second mask.

Further, a method for calculating the estimation threshold θ is:

$$θ = \overline{H} + {σ}_{H} ,$$

where H̅ denotes a mean value of the information entropy of the channels of the modality images,

$$\overline{H} = \frac{{H}_{RGB} + {H}_{Depth} + {H}_{IR}}{3} ,$$

H_{RGB} is the information entropy of the first RGB image, H_{Depth} is the information entropy of the first depth image, and H_{IR} is the information entropy of the first infrared image; and σ_{H} denotes a standard deviation of the information entropy of the channels of the modality images, and

$${σ}_{H} = \sqrt{\frac{{( {H}_{RGB} - \overline{H} )}^{2} + {( {H}_{Depth} - \overline{H} )}^{2} + {( {H}_{IR} - \overline{H} )}^{2}}{3}} .$$

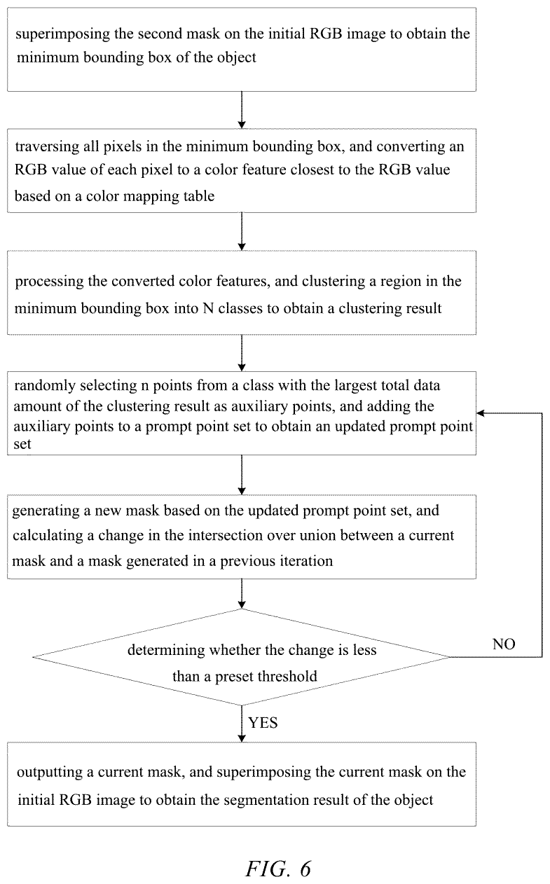

As shown in FIG. 6, a method for obtaining a segmentation result of the object in S5 is as follows:
S51: superimposing the second mask on the initial RGB image to obtain the minimum bounding box of the object;
S52: traversing all pixels in the minimum bounding box, and converting an RGB value of each pixel to a color feature in a ColorNames (CN for short) form closest to the RGB value based on a color mapping table by calculating a Euclidean distance or another similarity measurement between an RGB value of each pixel and a color in the mapping table, where
a type of the color mapping table includes, but is not limited to, a WEB standard color table, an X11 color name list, or another defined color classification system, and content of the color mapping table includes a series of common color names and RGB value ranges corresponding to the color names;
S53: inputting the converted color features into a K-means algorithm, and clustering a region in the minimum bounding box into N classes by calculating a distance between the color feature of each pixel and each clustering center to obtain a clustering result;
S54: randomly selecting n points from a class with the largest total data amount of the clustering result as auxiliary points, and adding the auxiliary points to a prompt point set to obtain an updated prompt point set;
S55: generating a new mask based on the updated prompt point set using a Segment Anything Model (SAM for short) algorithm, and calculating a change ΔIoU in the intersection over union (IoU for short) between the current mask and a mask generated in a previous iteration:

$$Δ IoU = 1 - IoU = 1 - \frac{\vert A ⋂ B \vert}{\vert A ⋃ B \vert} ,$$

where A is the mask generated in the previous iteration, and B is the current mask; and
S56: determining whether the change ΔIoU is less than a preset threshold ε:
if the change is not less than the preset threshold, returning to Step S54; and
if the change is less than the preset threshold, stopping iterations, outputting a current mask, and superimposing the current mask on the initial RGB image to obtain the segmentation result of the object.

### Embodiment 2

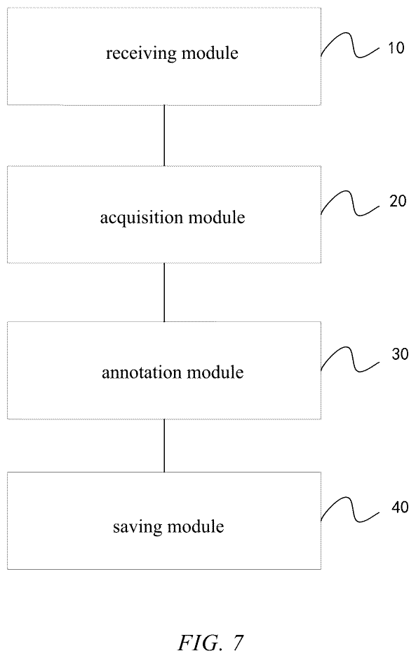

As shown in FIG. 7, the present invention further provides an image annotation tool, including the following modules:
a receiving module 10, configured to receive at least one creation instruction input through an object interface, and when a plurality of creation instructions are input, queue the creation instructions based on priority or submission order;
an acquisition module 20, configured to acquire a target quantity of images to be annotated based on a resource address included in the creation instruction, where in addition to the support for a single resource address, batch importing of an image list or directory path is also supported, providing basic image preprocessing options, for example, zooming, cropping, and rotation;
an annotation module 30, configured to automatically annotate the image to be annotated using the object segmentation method based on multimodal data fusion in Embodiment 1, also allow a user to manually adjust a boundary box or a segmentation region based on automatic annotation, and display an annotation result on the object interface, thereby facilitating the real-time viewing and verification by the user; and
a saving module 40, configured to save the annotation result in multiple file formats, where the file formats include, but are not limited to, xml, txt, JSON, and CSV, and the module allows the user to select an output format to save different versions for each annotation task, thereby facilitating the tracking a modification history.

In addition, the image annotation tool provided in this embodiment may further analyze annotation data and generate a statistical report, thereby assisting the user in understanding the progress and quality of annotation, and can further interface with a cloud storage service, thereby achieving seamless data uploading and downloading.

In summary, the present invention aims to improving the precision and stability of object segmentation by comprehensively using information of RGB images, infrared images, and depth images. The method achieves the effective segmentation of an object through a series of steps such as image alignment, feature point matching, mask generation, information entropy calculation, and weight fusion, and further improves the quality of a segmentation result using an iteration optimization strategy. In addition, the present invention can achieve the precise segmentation of an object, and is applicable to multiple fields such as autonomous driving, medical image analysis, and security surveillance systems.

Persons skilled in the art should understand that the embodiments of the present application may be provided as a method, a system, or a computer program product. Therefore, the present application may use a form of a hardware-only embodiment, a software-only embodiment, or an embodiment with a combination of software and hardware. In addition, the present application may use a form of a computer program product implemented on one or more computer-usable storage media (including, but not limited to, a disk memory, a CD-ROM, an optical memory, and the like) that include computer-usable program code.

The present application is described with reference to the flowcharts and/or block diagrams of the method, the device (system), and the computer program product according to the embodiments of the present application. It should be understood that computer program instructions can achieve each procedure and/or block in the flowcharts and/or block diagrams and a combination of procedures and/or blocks in the flowcharts and/or block diagrams. The computer program instructions may be provided for a general-purpose computer, a dedicated computer, an embedded processor, or a processor of another programmable data processing device to generate a machine, so that the instructions executed by the computer or the processor of the another programmable data processing device generate an apparatus for implementing a specific function in one or more procedures in the flowcharts and/or in one or more blocks in the block diagrams.

These computer program instructions may be stored in a computer-readable memory that can instruct the computer or any other programmable data processing device to work in a specific manner, so that the instructions stored in the computer-readable memory generate an artifact that includes an instruction apparatus. The instruction apparatus implements a specific function in one or more processes in the flowcharts and/or in one or more blocks in the block diagrams.

The computer program instructions may alternatively be loaded onto a computer or another programmable data processing device, so that a series of operations and steps are performed on the computer or the another programmable device, to generate computer-implemented processing. Therefore, the instructions executed on the computer or the another programmable device provide steps for implementing a specific function in one or more procedures in the flowcharts and/or in one or more blocks in the block diagrams.

Obviously, the foregoing embodiments are merely examples for clear description, rather than a limitation to implementations. For a person of ordinary skill in the art, other changes or variations in different forms may also be made based on the foregoing description. All implementations cannot and do not need to be exhaustively listed herein. Obvious changes or variations that are derived there from still fall within the scope of protection of the present invention.

What is claimed is:

1. An object segmentation method based on multimodal data fusion, comprising steps of:
S1: acquiring an initial RGB image, an initial infrared image, and an initial depth image that contain an object;
S2: aligning the initial RGB image, the initial infrared image, and the initial depth image to obtain a first RGB image, a first infrared image, and a first depth image in a same coordinate system respectively;
S3: specifying an initial prompt point in the first RGB image, and acquiring first masks characterizing an object region from the first RGB image, the first infrared image, and the first depth image through the initial prompt point respectively;
S4: fusing pixel values of the images in different modalities based on the first masks of the first RGB image, the first infrared image, and the first depth image to obtain a second mask; and
S5: determining a minimum bounding box of the object based on the second mask, and calibrating the minimum bounding box to obtain a segmentation result of the object.

2. The object segmentation method based on multimodal data fusion according to claim 1, wherein a method for obtaining a first RGB image, a first infrared image, and a first depth image in a same coordinate system in S2 comprises:
S21: extracting feature points from the initial RGB image, the initial infrared image, and the initial depth image respectively, wherein each feature point has one feature descriptor, and the feature descriptor is an encoded vector that contains local information surrounding the feature point;
S22: constructing one approximate nearest neighbor search data structure for a feature descriptor set of each modality image;
S23: randomly selecting an approximate nearest neighbor search data structure of a modality image, and searching the approximate nearest neighbor search data structure based on a feature point descriptor of another modality image to obtain candidate matching points;
S24: obtaining a geometric relationship estimation matrix between any two modality images based on the candidate matching points; and
S25: aligning all the modality images based on the geometric relationship estimation matrix to obtain the first RGB image, the first infrared image, and the first depth image in the same coordinate system.

3. The object segmentation method based on multimodal data fusion according to claim 1, wherein a method for acquiring first masks characterizing an object region from the first RGB image, the first infrared image, and the first depth image in S3 comprises:
S31: selecting one or more initial prompt points from the object region of the first RGB image; and
S32: obtaining the first mask of the first RGB image based on the initial prompt point, and mapping the coordinates of the initial prompt point into the first infrared image and the first depth image respectively to obtain the first mask of the first infrared image and the first mask of the first depth image.

4. The object segmentation method based on multimodal data fusion according to claim 1, wherein a method for obtaining a second mask in S4 comprises:
S41: obtaining information entropy of a channel of each modality image based on the first masks of the first RGB image, the first infrared image, and the first depth image;
S42: obtaining, based on the information entropy of the channel of each modality image, a weight corresponding to the first mask of the modality image;
S43: performing weighted fusion on the first masks of the three modality images based on the weight corresponding to the first mask of the modality image to obtain a fused value of each pixel; and
S44: comparing the fused value of each pixel with an estimation threshold, and retaining pixels whose fused value is greater than the estimation threshold to obtain the second mask.

5. The object segmentation method based on multimodal data fusion according to claim 4, wherein a calculation method for obtaining information entropy of a channel of each modality image in S41 comprises:
a calculation formula for the information entropy H_{RGB} of the channel of the first RGB image is:
$${H}_{RGB} = - {\sum }_{i = 0}^{255} {P}_{RGB} ( {i}_{RGB} ) log {P}_{RGB} ( {i}_{RGB} ) ,$$
a calculation formula for the information entropy H_{IR} of the channel of the first infrared image is:
$${H}_{IR} = - {\sum }_{i = 0}^{255} {P}_{IR} ( {i}_{IR} ) log {P}_{IR} ( {i}_{IR} ) ,$$
a calculation formula for the information entropy H_{Depth} of the channel of the first depth image is:
$${H}_{Depth} = - {\sum }_{i = 0}^{255} {P}_{Depth} ( {i}_{Depth} ) log {P}_{Depth} ( {i}_{Depth} ) ,$$
wherein P_{RGB}(I_{RGB}), P_{Depth}(i_{Depth}), and P_{IR}(i_{IR}) are respectively probability distributions of an RGB image, a depth image, and an infrared image on the pixel values i_{RGB}, i_{Depth}, and i_{IR}.

6. The object segmentation method based on multimodal data fusion according to claim 4, wherein a method for obtaining a weight corresponding to the first mask of the modality image in S42 is: using the reciprocal of the information entropy of the channel of each modality image as the weight corresponding to the first mask.

7. The object segmentation method based on multimodal data fusion according to claim 4, wherein a method for obtaining a fused value F(x,y) of each pixel in S43 comprises:
$$F ( x , y ) = \frac{{W}_{RGB} \cdot {RGB}_{mask} ( x , y ) + {W}_{IR} \cdot {IR}_{m a s k} ( x , y ) + {W}_{Depth} \cdot {Depth}_{mask} ( x , y )}{{W}_{RGB} + {W}_{IR} + {W}_{Depth}} ,$$
wherein W_{RGB} is the weight of the channel of the first RGB image, and RGBₘₐₛₖ(x,y) is the coordinates of any pixel in the first mask of the first RGB image; W_{IR} is the weight of the channel of the first infrared image, IRₘₐₛₖ(x,y) is the coordinates of any pixel in the first mask of the first infrared image; and W_{Depth} is the weight of the channel of the first depth image, and Depthₘₐₛₖ(x,y) is the coordinates of any pixel in the first mask of the first depth image.

8. The object segmentation method based on multimodal data fusion according to claim 4, wherein a method for calculating the estimation threshold θ is:
$$θ = \overline{H} + {σ}_{H} ,$$
wherein H̅ denotes a mean value of the information entropy of the channels of the modality images,
$$\overline{H} = \frac{{H}_{RGB} + {H}_{Depth} + {H}_{IR}}{3} ,$$
H_{RGB} is the information entropy of the first RGB image, H_{Depth} is the information entropy of the first depth image, and H_{IR} is the information entropy of the first infrared image; and σ_{H} denotes a standard deviation of the information entropy of the channels of the modality images, and
$${σ}_{H} = \sqrt{\frac{{( {H}_{RGB} - \overline{H} )}^{2} + {( {H}_{Depth} - \overline{H} )}^{2} + {( {H}_{IR} - \overline{H} )}^{2}}{3}} .$$

9. The object segmentation method based on multimodal data fusion according to claim 1, wherein a method for obtaining a segmentation result of the object in S5 comprises:
S51: superimposing the second mask on the initial RGB image to obtain the minimum bounding box of the object;
S52: traversing all pixels in the minimum bounding box, and converting an RGB value of each pixel to a color feature closest to the RGB value based on a color mapping table;
S53: processing the converted color features, and clustering a region in the minimum bounding box into N classes to obtain a clustering result;
S54: randomly selecting n points from a class with the largest total data amount of the clustering result as auxiliary points, and adding the auxiliary points to a prompt point set to obtain an updated prompt point set;
S55: generating a new mask based on the updated prompt point set, and calculating a change in the intersection over union between a current mask and a mask generated in a previous iteration; and
S56: determining whether the change is less than a preset threshold:
if the change is not less than the preset threshold, returning to Step S54; and
if the change is less than the preset threshold, stopping iterations, outputting a current mask, and superimposing the current mask on the initial RGB image to obtain the segmentation result of the object.

10. An image annotation tool, comprising:
a receiving module, configured to receive at least one creation instruction input through an object interface, and when a plurality of creation instructions are input, queue the creation instructions based on priority or submission order;
an acquisition module, configured to acquire a target quantity of images to be annotated based on a resource address comprised in the creation instruction;
an annotation module, configured to automatically annotate the image to be annotated using the object segmentation method based on multimodal data fusion according to claim 1, and display an annotation result on the object interface; and
a saving module, configured to save the annotation result in multiple file formats.
